(19) United States
(12) Patent Application Publication
(10) Pub. No.: US 2025/0290753 A1
(43) Pub. Date: Sep. 18, 2025

(54) METHOD AND SYSTEM FOR DETERMINING AN INFERRED LOCATION OF A DEVICE AND SPOOF DETECTION

(71) Applicants: THE BOEING COMPANY, Arlington, VA (US); The Board of Trustees of the University of Illinois, Urbana, IL (US)

(72) Inventors: Josh D. Eckhardt, St. Peters, MO (US); Jae H. Kim, Bellevue, WA (US); Matthew Caesar, Champaign, IL (US)

(21) Appl. No.: 18/608,305

(22) Filed: Mar. 18, 2024

(51) Int. Cl. G01C 21/16

(52) U.S. Cl. CPC G01C 21/165

(57) ABSTRACT

A device includes two or more sensors. The device also includes one or more processors coupled to a memory and configured to obtain first sensor data from a first sensor of the two or more sensors and obtain second sensor data from a second sensor of the two or more sensors. The processors are further configured to determine a first position estimate of the device based on the first sensor data and determine a second position estimate of the device based on the second sensor data. The processors are further configured to provide input data based on the first position estimate and the second position estimate to a filter to determine an inferred location of the device and a confidence value associated with the inferred location. The processors are further configured to control navigation of the device based, at least in part, on the inferred location.

### FIELD OF THE DISCLOSURE

The present disclosure is generally related to determining an inferred location of a device and detecting a spoof incident.

### BACKGROUND

Vehicles, such as aircrafts, water vehicles, ground vehicles, and uncrewed vehicles can employ navigational systems to determine a position. As a non-limiting example, a particular vehicle can employ a Global Navigation Satellite System (GNSS) to determine the position of the particular vehicle. However, because the GNSS sends satellite-based signals to the particular vehicle that enable the particular vehicle to determine its position, the process can be subject to spoofing attacks. As a non-limiting example, a third party (e.g., a spoofer) can corrupt the integrity of one or more of the satellite-based signals used by the particular vehicle in determining its position. To illustrate, the third party can create a fake signal that is in phase with an authentic satellite-based signal from the GNSS but that is also stronger than the authentic satellite-based signal. As a result, the particular vehicle can detect and use the fake signal in determining its position.

Accordingly, there is a need for a method and system configured to determine inferred location of a vehicle and detect spoofing attacks.

### SUMMARY

In a particular implementation, a device includes two or more sensors and one or more processors coupled to a memory. The one or more processors are configured to obtain first sensor data from a first sensor of the two or more sensors and obtain second sensor data from a second sensor of the two or more sensors. The one or more processors are further configured to determine a first position estimate of the device based on the first sensor data and determine a second position estimate of the device based on the second sensor data. The one or more processors are also configured to provide input data based on the first position estimate and the second position estimate to a filter to determine an inferred location of the device and a confidence value associated with the inferred location. The one or more processors are further configured to control navigation of the device based, at least in part, on the inferred location.

In a particular implementation, a method includes obtaining first sensor data from a first sensor. The method includes obtaining second sensor data from a second sensor. The method includes determining a first position estimate of a device based on the first sensor data. The method includes determining a second position estimate of the device based on the second sensor data. The method includes providing input data based on the first position estimate and the second position estimate to a filter to determine an inferred location of the device and a confidence value associated with the inferred location. The method includes controlling navigation of the device based, at least in part, on the inferred location.

In another particular implementation, a non-transitory computer-readable medium stores instructions that, when executed by one or more processors, cause the one or more processors to obtain first sensor data from a first sensor. The instructions also cause the one or more processors to obtain second sensor data from a second sensor. The instructions also cause the one or more processors to determine a first position estimate of a device based on the first sensor data. The instructions also cause the one or more processors to determine a second position estimate of the device based on the second sensor data. The instructions also cause the one or more processors to provide input data based on the first position estimate and the second position estimate to a Kalman filter to determine an inferred location of the device and a confidence value associated with the inferred location. The instructions also cause the one or more processors to control navigation of the device based, at least in part, on the inferred location.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a diagram that illustrates a system configured to process data to determine an inferred location of a device and detect a spoof incident.

FIG. 2 is an illustration of a graph depicting position error with a received signal strength indicator (RSSI), a graph depicting position error with an inertial measurement unit (IMU) and a graph depicting effect of swarm density on root-mean-square error (RMSE).

FIG. 3 is an illustration of a graph depicting distribution of positional error, a graph depicting true trajectory versus computed trajectory, and a graph depicting time-series variation in position error.

FIG. 4 is an illustration of a graph depicting various position estimates based on weighed fusion of IMU data and RSSI data.

FIG. 5 is a flow chart of a method of determining an inferred location.

FIG. 6 is a block diagram of a computing environment including a computing device configured to support aspects of computer-implemented methods and computer-executable program instructions (or code) according to the present disclosure.

### DETAILED DESCRIPTION

Modern conflict areas are highly contested environments with an electronic and cyber threat that is continually advancing in capability. Due to the advent of software-defined radio capabilities as well as increasingly sophisticated hardware, the ability to “jam” or spoof communications in advanced forms is increasing. Unfortunately, the ability of modern combatants to conduct missions is ever more intertwined with satellite-hosted localization systems such as the Global Positioning System (GPS). Such systems are often used for planning, logistics and routing of assets, as well as navigation of autonomous platforms. While large platforms may make use of technologies to counter the effects of GPS spoofing via redundant and dissimilar radio stacks, smaller platforms such as Air Launched Effects (ALEs), with more limited capabilities, can be vulnerable to spoofing. Disrupting location services for such platforms can disrupt missions. Accordingly, there is a need for systems and methods to remediate spoofing of GPS signals for smaller or autonomous platforms.

Aspects disclosed herein present systems and methods for determining an inferred location of a device and detecting a spoof incident. The system combines data from non-positional sensors (e.g., cameras, IMUs) to infer a device's location and confidence level. Each of the sensors includes Positional Inference Drivers (PIDs). Each PID converts its data (e.g., camera image) into location information. Each PID is specific to the sensor type and each PID cleans and pre-processes the obtained data. The system then uses a filter, such as a Kalman Filter, to combine location information from all the PIDs and considers each sensor's confidence level to determine an inferred location of the device and determine whether the received GPS signal is spoofed. Configuration settings can be used to adjust weights for specific scenarios (e.g., low GPS trust in areas with interference) or sensors. Based, at least in part, on the inferred location, the system can control the navigation of the device.

The techniques and systems described herein provide a technical advantage of determining more reliable location of the device than GPS alone, especially in spoofing situations. The modular architecture of the system supports different sensor types and future extensions. Further, the system provides a robust and dynamic way for devices to navigate using their onboard sensors, even in challenging environments.

The figures and the following description illustrate specific exemplary implementations. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific implementations or examples described below, but by the claims and their equivalents.

Particular implementations are described herein with reference to the drawings. In the description, common features are designated by common reference numbers throughout the drawings.

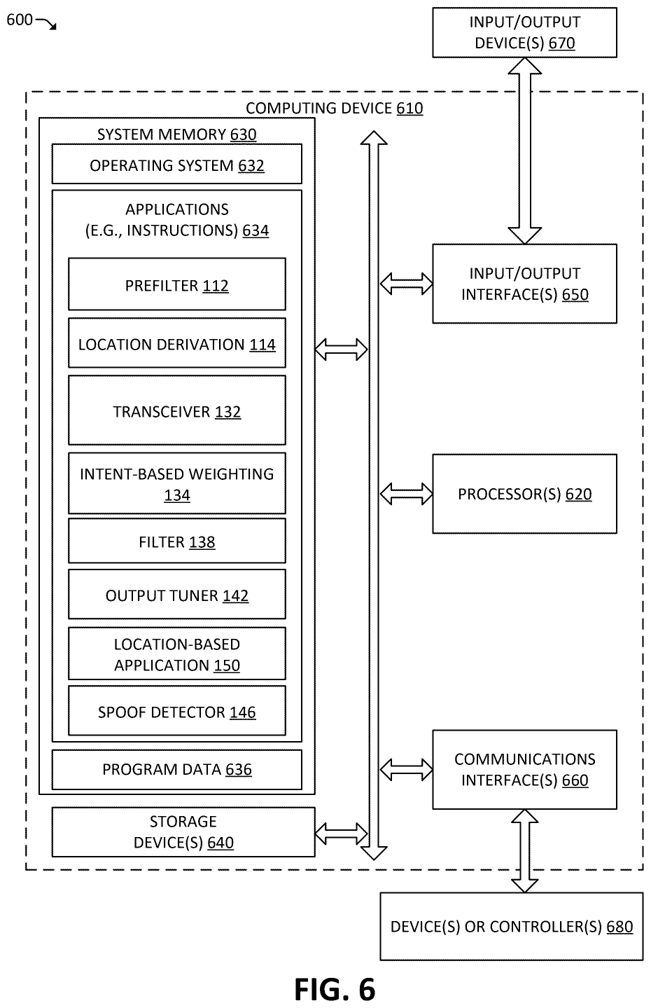

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 6 depicts a computing device 610 including one or more processors (“processor(s)” 620 in FIG. 6), which indicates that in some implementations the computing device 610 includes a single processor 620 and in other implementations the computing device 610 includes multiple processors 620. For ease of reference herein, such features are generally introduced as “one or more” features and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

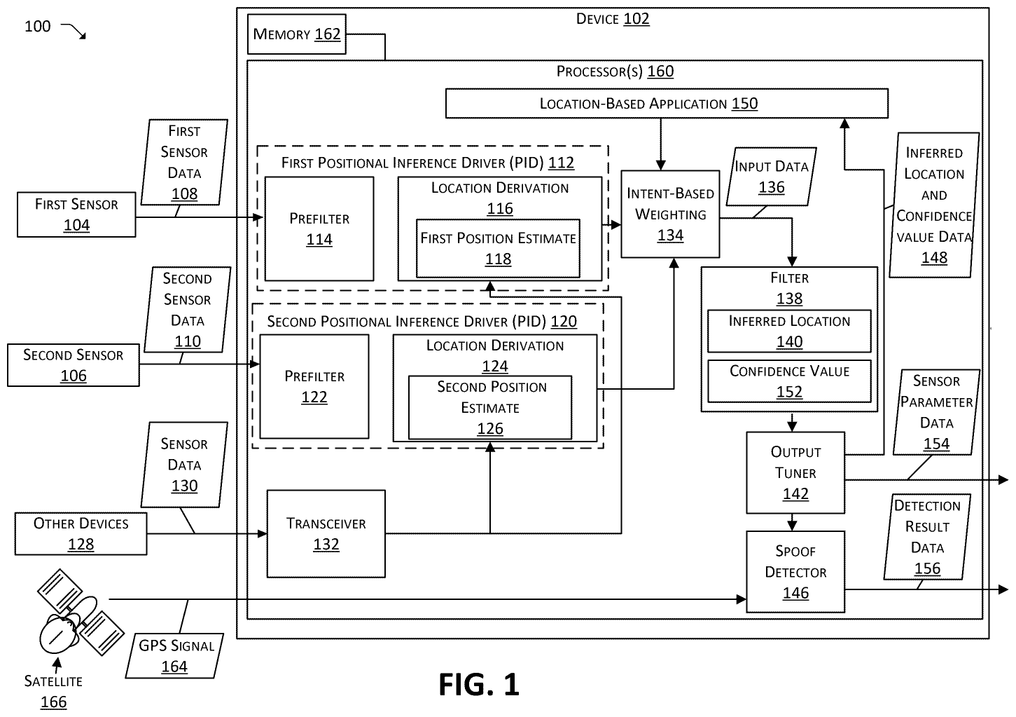

FIG. 1 is a diagram that illustrates a system 100 configured to process data (e.g., first sensor data 108 and second sensor data 110) to determine an inferred location of a device 102. The system 100 is also configured to detect whether a GPS signal 164 has been compromised (e.g., spoofed) based on a comparison of the inferred location to the GPS signal 164. The device 102 can be a vehicle, such as an aircraft, a water vehicle, a ground vehicle, an uncrewed vehicle, Air Launched Effects (ALEs), and so forth. The device 102 includes two or more sensors (e.g., a first sensor 104 and a second sensor 106). The first sensor 104 and the second sensor 106 can be non-positional sensors that include an inertial measurement unit (IMU), a communication sensor, a receiver configured to generate a received signal strength indicator (RSSI) based on a received signal, a camera, and so forth. An IMU is configured to measure acceleration, orientation, angular rates, and other gravitational forces to facilitate dead reckoning location. A communication sensor is configured to obtain position data (e.g., global positioning system (GPS) coordinates) or other sensor data from other devices. The receiver is configured to measure the power level and/or the angle of arrival of an RSSI to facilitate estimation of a distance and direction to neighboring devices or ground stations. A camera is configured to capture images to enable use of computer vision techniques to estimate distance and direction to other devices, ground features, or a combination thereof. In the implementation shown in FIG. 1, two sensors (e.g., the first sensor 104 and the second sensor 106) are depicted, but in other implementations, a different number (e.g., 3, 4, 5, or some other number) of sensors are included in the device 102.

The device 102 includes one or more processors 160 coupled to a memory 162. The one or more processors 160 are configured to obtain first sensor data 108 from the first sensor 104 of the two or more sensors. For example, the first sensor 104 can include an IMU, in which case the first sensor data 108 includes acceleration, orientation, angular rates, other gravitational forces, or a combination thereof. The one or more processors are configured to obtain second sensor data 110 from the second sensor 106 of the two or more sensors. For example, the second sensor 106 can include an RSSI sensor, in which case the second sensor data 110 includes measurements of a power level of a received radio signal and angle of arrival to estimate a distance and angle to neighboring devices or ground stations.

The device 102 includes a positional inference driver (PID) for each individual sensor. For example, the first sensor 104 is coupled to or equipped with a first PID 112 and the second sensor 106 is coupled to or equipped with a second PID 120. In the implementation shown in FIG. 1, two PIDs 112, 120 are depicted, but in other implementations, a different number (e.g., 3, 4, 5, or some other number) of PIDs are included in the device 102.

The first PID 112 includes a prefilter 114 and a location derivation 116. The second PID 120 includes a prefilter 122 and a location derivation 124. Each of these PIDs obtain sensor data, as described above, from the individual sensors and determines a position estimate of the device 102 based on the sensor data. The PIDs 112, 120 are run independently for each sensor 104, 106, as each PID maintains state which is specific to that specific sensor. Each PID acquires the sensor data 108, 110 at a frequency that is based on the sensor type and measurement constraints. A technical advantage of the PIDs is that since each PID is specific to a particular sensor type, using the PIDs enables a modular architecture as different devices or device platforms may have different sensor types.

The prefilters 114, 122 are configured to pre-filter the sensor data, which can include cleaning the sensor data (e.g., low-pass filtering, high-pass filtering, noise reduction), down sampling the sensor data to remove biases, smoothing the sensor data signal, removing background noise, or combinations thereof.

Filtered sensor data from each of the prefilters 114, 122 is sent to a corresponding one of the location derivations 116, 124. The location derivation 116 is configured to determine a first position estimate 118 of the device 102 based on the filtered first sensor data 108 from the prefilter 114, and the location derivation 124 is configured to determine a second position estimate 126 of the device 102 based on the filtered second sensor data 110 from the prefilter 122. Specific operations performed by the location derivations 116, 124 to determine the position estimates 118, 126 depend on the sensor types of the sensors 104, 106.

For example, in implementations in which the first PID 112 is coupled to an IMU (e.g., the first sensor 104 is an IMU), the location derivation 116 receives sensor data such as the angular speed and acceleration on three axes. In this example, the location derivation 116 determines the first position estimate 118 by processing the angular speed and acceleration information to estimate a change of position of the device 102 from a prior known position, as described further below. A technical advantage of using an IMU as one of the sensors 104, 106 is that IMUs are robust and are intrinsic sensors. As an intrinsic sensor, the IMU does not rely on extrinsic information from its surroundings which makes it difficult to jam or spoof.

As another example, in implementations in which the second PID 120 is coupled to a camera (e.g., the second sensor 106 is a camera), the location derivation 124 receives a sequence of digital images. In this example, the location derivation 124 uses visual odometry to estimate the displacement between frames and then determines the second position estimate 126 based on the position and altitude changes.

In another example, in implementations in which the first PID 112 is coupled to a light detection and ranging (LiDAR) system (e.g., the first sensor 104 is a LiDAR system), the location derivation 116 receives a distance estimate of the device 102 to an object. The location derivation 124 determines the first position estimate 118 based on the estimated distance of the device 102 to the object.

In another example, in implementations in which the second PID 120 is coupled to a signal strength sensor (e.g., the second sensor 106 is a signal strength sensor configured to generate or receive an RSSI), the location derivation 124 receives signal strength data for signals sent to or received from other devices 128 that are nearby (e.g., other vehicles or ground stations). The location derivation 124 determines the second position estimate 126 based on estimates about distances between the device 102 and the other devices 128, ground stations, or a combination thereof.

In implementations in which one of the sensors 104, 106 is an IMU, the PID 112, 120 associated with the IMU can generate a position estimate as follows. A typical IMU is a six (6) degree of freedom sensor that includes one or more gyroscopes and one or more accelerometers. The gyroscopes and accelerometers provide the angular velocity and translational acceleration on three axes.

$${R}_{t + 1} = {R}_{t} exp ( {( {ω}_{t} dt )}_{x} ) , \qquad Equation 1$$

$${v}_{t + 1} = {v}_{t} + ( {R}_{t} {a}_{t} - g ) dt , \qquad Equation 2$$

$${p}_{t + 1} = {p}_{t} + {v}_{t} d t + 1 / 2 ( {R}_{t} {a}_{t} - g ) d {t}^{2} . \qquad Equation 3$$

Given a known initial location (e.g., pₜ) and altitude, Equations 1-3 can be used to transform the sensor data from the IMU into a current position estimate (e.g., pₜ₊₁) by observing rotation and acceleration across time. The direction cosine matrix Rₜ represents the altitude of the device 102. Additionally, vₜ and pₜ represent the velocity and position of the device 102 at time t, respectively. Exp((ωₜdt)ₓ) represents the corresponding cosine rotation matrix for altitude changes from time t to t+1. The Rₜaₜ transforms the acceleration from a body frame into a reference frame where compensation for gravity g is performed.

In some embodiments, the prefilters 114, 122 are configured to use Equations 4and 5 (e.g., gyroscope, and accelerometer noise models) to remove one or more errors or uncertainties:

$${ω}_{m} = ω + {ω}_{b} + {ω}_{n} , \qquad Equation 4$$

$${α}_{m} = a + {a}_{b} + {a}_{n} , \qquad Equation 5$$

where ωₘ and αₘ represent measured angular velocity and acceleration, ω_{b} and a_{b} represent the bias, ωₙ and aₙ represents zero-mean Gaussian noise. The non-static biases ω_{b} and a_{b} follow a random walk process, where ϵᵣ^{a}, ϵᵣ^{ω} are Gaussian noises represented below in Equations 6 and 7.

$${δω}_{b} = {ω}_{b}^{t} - {ω}_{b}^{t - 1} = {ϵ}_{r}^{ω} \qquad Equation 6$$

$${δα}_{b} = {α}_{b}^{t} - {α}_{b}^{t - 1} = {ϵ}_{r}^{α} \qquad Equation 7$$

In implementations in which one of the sensors 104, 106 is the receiver configured to generate the RSSI, the PID 112, 120 associated with the receiver can generate a position estimate as follows. RSSI reflects the strength of a received signal at the receiver and can be used by the receiver to infer the distance between a signal transmitter and the receiver. Unlike GPS, which requires high accuracy comparison of times of arrival of radio signals and satellite ephemeris data, RSSI measurement uses basic radio receivers. The position of the device 102 relative to signal transmitters of other devices 128 can be estimated using multilateration based on the RSSI measurements associated with the other devices 128 or stations. Equation 8 can be used to estimate the distance (d) between the device 102 and one of the other devices 128 based on an RSSI measurement (RSSI), as shown below.

$$RSSI = A - 10 \cdot η \cdot {log}_{10} ( d ) + {ϵ}_{RSSI} \qquad Equation 8$$

where A is the received signal strength at a reference distance, η is the path loss exponent, d is the actual distance between receiver and transmitter, and ϵ_{RSSI} is a zero-mean Gaussian random variable following ϵ_{RSSI}˜N(0, σ_{RSSI}) that models the noise in the measurement. In a free-space environment, path loss exponent η=2. Based on the RSSI measurement, an empirical estimator of the distance is determined using Equation 8.

Equation 9 determines a distance between a transmitter and the receiver based on the received signal strength indicator (RSSI), as shown below,

$$\hat{d} = {10}^{\frac{A - RSSI}{10 \text{?}}} \qquad Equation 9$$

$$\text{?} \text{indicates text missing or illegible when filed}$$

where \hat{d} represents the estimated distance between the transmitter (e.g., the other devices 128) and receiver (e.g., receiver coupled to the device 102), A is the received signal strength at a reference distance, and η is the path loss exponent.

In some implementations, a set of n RSSI measurements \hat{d}ᵢ and corresponding known locations of the other devices 128 pᵢ=(xᵢ, yᵢ, zᵢ) for i=1, . . . , n, to determine the location of the device 102, p=(x, y, z) using multilateration with the least squares method, as shown below in Equation 10.

$$\hat{p} = {arg min}_{p} {\sum }_{i = 1}^{n} {( {\hat{d}}_{i} - ‖ p - {p}_{i} ‖ )}^{2} \qquad Equation 10$$

[symbol] other device 128 that is nearby, \hat{d}ᵢ represents the RSSI-based distance estimation for the i^{th} neighboring other device 128. ∥⋅∥ denotes the Euclidean distance between two points. Equation 8 expresses finding the value of p that minimizes the sum of squared differences between the measured distances and the actual distances between the estimated position of device 102 and the positions of the other devices 128. Equation 10 can be solved by using various non-linear least squares algorithms, such as the Levenberg-Marquardt algorithm.

In some implementations, the device 102 includes a transceiver 132 that is configured to receive the sensor data 130 from the other devices 128. The sensor data 130 can include raw or filtered data that was obtained via one or more sensors coupled to the other devices 128, position estimates, inferred location and confidence values associated with the inferred locations, or a combination thereof. The transceiver 132 includes a receiver configured to receive the sensor data 130 and provide the sensor data 130 to the location derivation 116, 124 for the determination of the first position estimate 118, the second position estimate 126, or both. The system 100 may include a mesh network that enables the device 102 and the other devices 128 to share their sensor data 130 with each other. The other devices 128 may be configured to periodically exchange the sensor data 130 and/or other information relevant to estimating their current location. For example, the transceiver 132 or the location derivation 116, 124 may be configured to determine an RSSI based on the received signals indicated in the sensor data 130 and determine relative positions of the device 102 and each of the one or more other devices 128 based on the RSSI and known signal transmission parameters.

In another example, the transceiver 132 is configured to receive sensor data 130 from the other devices 128. In this example, the sensor data 130 can include information indicating a distance between two of the other devices 128 (e.g., a distance between the particular other device 128 that sent the sensor data 130 and another of the other devices 128). The location derivation 116, 124 is configured to determine a position estimate 118, 126 of the device 102 based on the sensor data 130 indicating the distance between the two of the other devices 128.

In another example, the transceiver 132 or the location derivation 116, 124 are configured to determine an angle of arrival of the sensor data 130. In this example, the transceiver 132 or the location derivation 116, 124 are configured to determine an estimate of an angle of one or more of the other devices 128 with respect to the device 102. Based on the estimate of angle, the transceiver 132 or the location derivation 116, 124 are configured to determine an estimate of position of the one or more of the other devices 128. Based on the estimate of positions of the one or more of the other devices 128, the location derivations 116, 124 are configured to determine a first position estimate 118 or a second position estimate 126 of the device 102.

Once the location derivations 116, 124 determine the first and second position estimates 118, 126, an intent-based weighting 134 applies one or more configuration settings to the first sensor data 108, the second sensor data 110, the first position estimate 118, the second position estimate 126, or a combination thereof, to generate input data 136 for the filter 138. The configuration settings can modify state parameters of the filter 138. For example, the configuration settings may indicate a first weighting associated with the first sensor data 108 and a second weighting associated with the second sensor data 110. The weighting associated with each sensor data (e.g., the first sensor data 108 and the second sensor data 110) can be user specified or automatically generated. For example, the weighting can be based on sensor resilience, reliability, weather conditions, or a combination thereof. The configuration settings can be based on an operational activity associated with the device 102 or an operating environment associated with the device 102.

In some embodiments, the intent-based weighting 134 can modify the state parameters of the filter 138 based on the configuration settings indicating a planned swarm movement pattern of the device 102 and one or more other devices 128. For example, where the planned swarm movement pattern is a formation or collective movement of the device 102 and the one or more other devices 128, the input data 136 is further based on the sensor data 130 (e.g., movement data) indicative of a position estimate within the formation of each of the one or more other devices 128 or movements of each of the one or more other devices 128 associated with the collective movement.

In another example, where the configuration settings include planned swarm movement pattern indicating that the other devices 128 are moving independently of one another (e.g., independent movements associated with each of the one or more other devices 128), the input data 136 is further based on the sensor data 130 (e.g., movement data) indicative of a position estimate for individual ones of the one or more other devices 128, where the intent-based weighting 134 applies a de-emphasized weighting associated with each position estimate (e.g., the first position estimate 118 and the second position estimate 126).

In some implementations, the input data 136 is further based on feedback based on an output (e.g., inferred location and confidence value data 148) of the filter 138. As described in more detail below, the filter 138 provides the inferred location and confidence value data 148 to a location-based application 150. The location-based application 150 receives the inferred location and confidence value data 148 and provides feedback to the intent-based weighting 134 for the purpose of revising and applying more accurate configuration settings to the first sensor data 108, the second sensor data 110, the first position estimate 118, the second position estimate 126, or a combination thereof.

The filter 138 is configured to determine an inferred location 140 of the device 102 and a confidence value 152 associated with the inferred location 140 based on the input data 136. The filter 138 can include linear filters or non-linear filters for determining the inferred location 140 of the device 102 and the confidence value. For example, the filter 138 can include an error state extended Kalman filter (ES-EKF). In this example, the input data 136 is processed using an ES-EKF algorithm (as shown below) to generate an inferred location 140 based on the first sensor data 108 and the second sensor data 110.

Algorithm 1 ES-EKF Algorithm

```
Input: xᵢₙᵢₜᵢₐₗ, Pᵢₙᵢₜᵢₐₗ, δxᵢₙᵢₜᵢₐₗ, uₘ, V, Q
Output: [symbol] , [symbol] x, P
loop [symbol]
  = CORRECTION [symbol] (uₘ [symbol] [symbol]   x) [symbol]
  ← F( [symbol] , u)
  P ← F [symbol] PF [symbol] ^{T} + G [symbol] QG [symbol] ^{T}
  if RSSI measurement available then
  | H = H [symbol] [symbol]    X [symbol]
  | K ← PH^{T} (HPH^{T} + V)⁻¹
  | P ← (I − KH)P
  | [symbol]  x ← K (y − h( [symbol] ))
  | [symbol]   = CORRECTION [symbol] ( [symbol] , [symbol] x)
end
end loop [symbol]
indicates data missing or illegible when filed
```

The kinematic state and the error state of the device 102 may be described by Equations 11 and 12:

$$x {=}^{Δ} {[ p , v , q ]}^{T} ∈ {ℝ}^{10} , \qquad Equation 11$$

$$δ x {=}^{Δ} {[ δ p , δ v , δθ , ab , ω b ]}^{T} ∈ {ℝ}^{15} , \qquad Equation 12$$

where p∈ [symbol] ³ represents position, v∈ [symbol] ³ represents velocity, q∈ [symbol] ⁴ is quaternion that represents the altitude. Error state δx, defines perturbation for position and velocity as δp=p−\hat{p}, δv=v−\hat{v}. Additionally, δθ∈ [symbol] ³ represents the difference between nominal and true altitude in Euler angle format, where

$$q = δ q ⊗ \hat{q} = {e}^{⋀} \frac{δ y}{2} δθ ⊗ \hat{q} .$$

The first sensor data 108 from the first sensor 104 is defined as uₘ [symbol] [aₘ, ωₘ]^{T}∈ [symbol] ⁶. The error state transition function for δx and the kinematic state transition function for x are formulated as follows in Equation 13:

$$δ x ← f ( x , δ x , {u}_{m} ) = {F}_{x} ( x , {u}_{m} ) \cdot δ x + {G}_{x} ( x ) \cdot w \qquad Equation 13$$

$$x ← F ( x , {u}_{m} )$$

The measurement noise aₙ, ωₙ and biased random walk noise δa_{b}, δω_{b}, are defined as w [symbol] [aₙ, ωₙ, δa_{b}, δω_{b}]^{T}∈ [symbol] ¹². The directional cosine matrix associated with quaternion q, is defined as R [symbol] R{q}∈SO. Fₓ and Gₓ are defined by Equation 14 and Equation 15 as follows:

$${F}_{x} ( x , {u}_{m} ) = [ \begin{matrix}{I}_{3} & {I}_{3} Δ t & 0 & 0 & 0 \\ 0 & {I}_{3} & {[ {Ra}_{\text{?}} ]}_{\text{?}} Δ t & R Δ t & 0 \\ 0 & 0 & {I}_{3} & 0 & - R Δ t \\ 0 & 0 & 0 & {I}_{3} & 0 \\ 0 & 0 & 0 & 0 & {I}_{3}\end{matrix} ] \qquad Equation 14$$

$${G}_{x} ( x ) = [ \begin{matrix}0 & 0 & 0 & 0 \\ R Δ t & 0 & 0 & 0 \\ 0 & R Δ t & 0 & 0 \\ 0 & 0 & {I}_{3} & 0 \\ 0 & 0 & 0 & {I}_{3}\end{matrix} ] \qquad Equation 15$$

$$\text{?} \text{indicates text missing or illegible when filed}$$

When k other devices 128 are nearby, the measurement equation is y=h(x)+v, where y∈ [symbol] ^{k} is the RSSI measurement vector, h is the RSSI measurement function and v∈ [symbol] ^{k}, is an extension of ϵ_{RSSI}, denoting a Gaussian noise vector with covariance V.

$$h ( x ) = A - 10 \cdot η \cdot {log}_{10} ( ‖ p - {p}_{i} ‖ ) \qquad Equation 16$$

The Jacobian matrix of H can be derived by chain rule and calculated by Hₓ and X_{δx} as in Equation 16.

$$H {=}^{Δ} \frac{\partial h}{\partial δ x} = \frac{\partial h}{\partial x} \frac{\partial x}{\partial δ x} = {H}_{\text{?}} \cdot {X}_{\text{?}} = [ \begin{matrix}\frac{\partial }{\partial x} {RSSI}_{1} \\ \frac{\partial }{\partial x} {RSSI}_{2} \\ ⋮ \\ \frac{\partial }{\partial x} {RSSI}_{k}\end{matrix} ] \cdot {X}_{\text{?}} \qquad Equation 16$$

$$\frac{\partial }{\partial x} {RSSI}_{i} = {[ \frac{\partial }{\partial {p}_{x}} {RSSI}_{i} , \frac{\partial }{\partial {p}_{y}} {RSSI}_{i} , \frac{\partial }{\partial {p}_{z}} {RSSI}_{i} , 0 , … , 0 ]}^{T} \qquad Equation 17$$

$$\text{?} \text{indicates text missing or illegible when filed}$$

where RSSIᵢ represents the RSSI measurement from the i^{th} other device 128 that is nearby.

$$\frac{\partial }{\partial x} RSS {I}_{i}$$

represents the Jacobian of RSSIᵢ to state x, in which it is related to position p. The derivation for X_{δx} may be marginal, except for the attitude quaternion q=[qₓ, q_{y}, q_{z}, q_{w}]^{T}.

In some implementations, multiple sensors can be used for a multi-staged sensor fusion using the filter 138. At each stage of sensor fusion, the system 100 obtains sensor data (e.g., first sensor data 108, second sensor data 110, third sensor data, sensor data 130, and so forth) from two or more individual sensors or the other devices 128 to generate inferred location and confidence value data 148 indicative of the inferred location 140 and the confidence value 152 associated with the inferred location 140. The inferred location and confidence value data 148 from a previous sensor fusion can be obtained from the location-based application 150 and used as a pseudo-sensor input for determining in this implementation the inferred location and confidence value data 148.

Once the inferred location and confidence value data 148 has been generated, the filter 138 sends the inferred location and confidence value data 148 to the output tuner 142 and the location-based application 150. The location-based application 150 is configured to provide the inferred location and confidence value data 148 to the intent-based weighting 134. The intent-based weighting 134 is configured to use the inferred location and confidence value data 148 to generate and refine subsequent input data 136.

The output tuner 142 is configured to determine whether one or more sensors (e.g., first sensor 104, second sensor 106) are experiencing anomalies (e.g., jamming). If a sensor is determined to be experiencing an anomaly, the output tuner 142 is configured to send sensor parameter data 154 to one or more devices, such as a ground station, to notify a user of the anomaly and when possible, allow the user the ability to resolve the anomaly.

A spoof detector 146 is configured to determine that a received GPS signal 164 from a satellite 166 has been compromised (e.g., spoofed). For example, the spoof detector 146 compares the inferred location 140 with the GPS signal to determine whether the GPS signal 164 has been compromised. In some implementations, if the spoof detector 146 determines that the GPS signal 164 has been compromised, the spoof detector 146 sends detection result data 156 to one or more devices, such as a ground station, to notify a user. During a time period in which the spoof detector 146 determines that the GPS signal 164 has been spoofed, the device 102 uses the sensor data 108, 110, 130 or a combination thereof, to determine an inferred location 140 of the device 102 and control its navigation based at least in part on the inferred location 140. In some implementations, if the spoof detector 146 determines that the GPS signal 164 has not been compromised, the device 102 continues to use the GPS signal 164 to determine its own location and control its navigation.

A technical advantage of the system 100 is that the using of the location data inferred based on multiple sensors enables a more reliable location determination than using GPS alone, especially in spoofing situations. The modular architecture of the system 100 supports different sensor types and future extensions. For example, the first sensor 104, the second sensor 106, or both can be switched from one type to a different sensor type, or one or more additional sensors can be coupled to the device 102. Further, the system 100 provides a robust and dynamic way for devices to navigate using their onboard sensors, even in challenging environments.

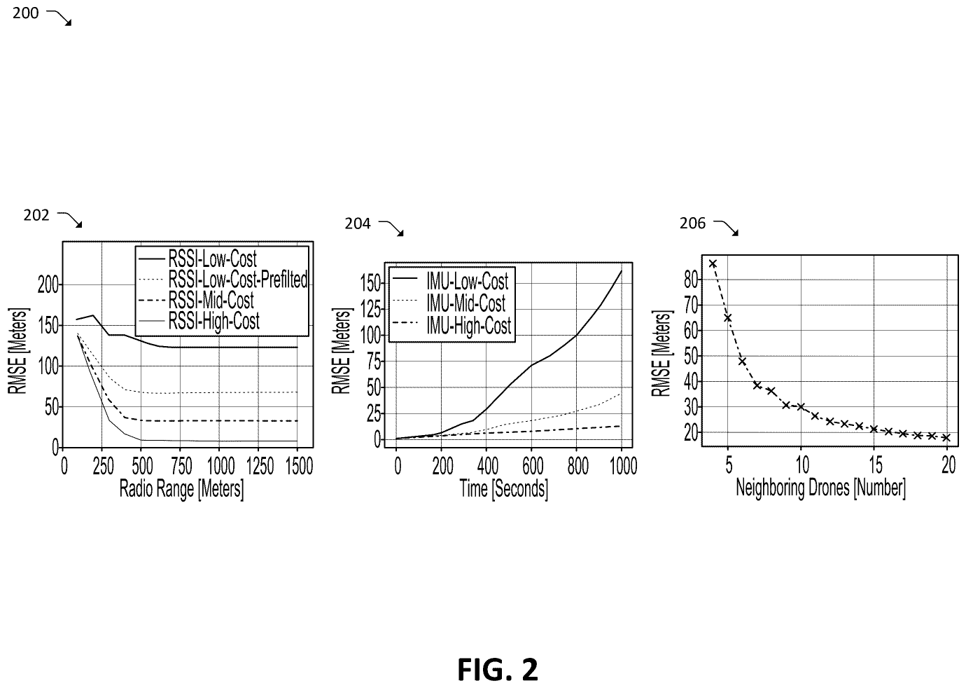

FIG. 2 is an illustration 200 of a graph 202 depicting position error with a received signal strength indicator (RSSI), a graph 204 depicting position error with an inertial measurement unit (IMU) and a graph 206 depicting the effect of swarm density on root-mean-square error (RMSE). The graph 202 shows the error in location estimation for varying radio ranges, using RSSI to correct the device's 102 inferred location 140. As the radio range increases, the device 102, can communicate with the other devices 128 to obtain sensor data 130 that includes RSSI values and location information, such as inferred locations determined for the other devices 128.

Graph 204 shows RMSE versus time for IMU-based location estimation. IMU-based correction provides accurate positioning for a short period, after the device 102 has been compromised. As depicted in the graph 204, the mean error as well as variance may increase over time. For low-cost IMUs the mean error can reach up to 160 meters at the end of a 10-minute simulation period.

The graph 206 depicts how the swarm density affects the accuracy of multilateration. As a non-limiting example, the range of available other devices 128 for the graph 206 varies from a minimum of 4, to a maximum of 20. During each iteration, K devices were randomly sampled, where 4<=K<=20. One or more equations as described above were executed using these sampled devices to estimate an inferred location. This process was repeated across multiple iterations to assess the accuracy of inferred location determination. The result, as shown in graph 206, is that the availability of a larger number of other devices 128 generally tends to decrease error.

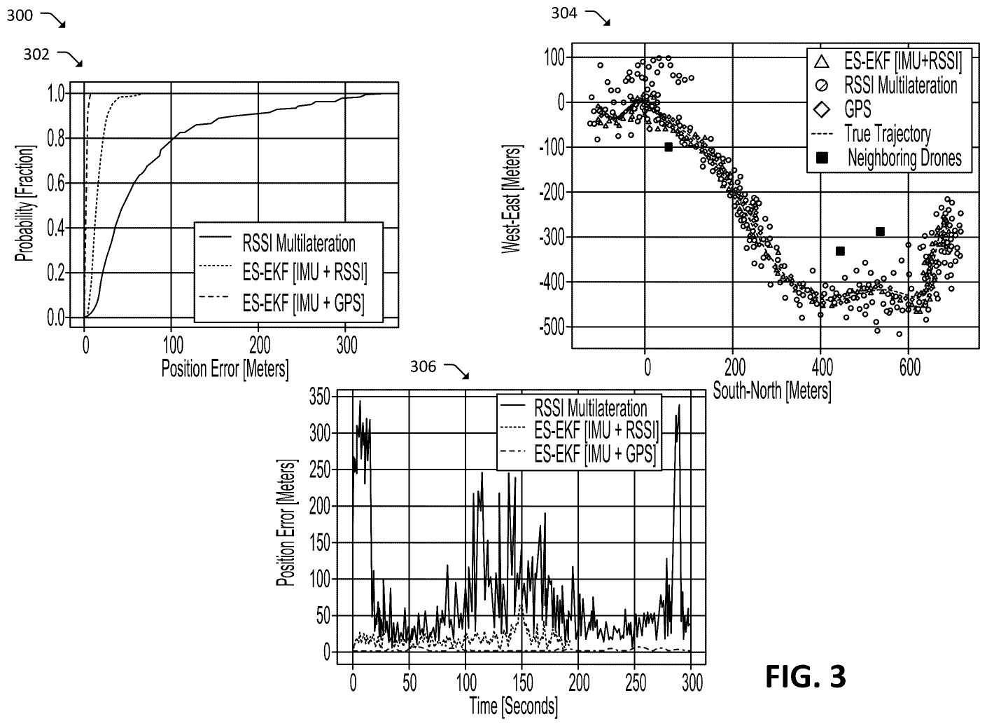

FIG. 3 is an illustration 300 of a graph 302 depicting distribution of positional error, a graph 304 depicting true trajectory versus computed trajectory, and a graph 306 depicting time-series variation in position error. The graph 302 shows that when the filter 138 is using RSSI multilateration, it has a much higher positioning error, as well as a long-tailing effect, the worst 10 percent deviations of which are beyond 174 meters. The filtering (e.g., ES-EKF fusion of IMU and RSSI) alleviates the long-tailing effect and increases the accuracy of positioning such that the worst 10 percent of deviations are only beyond 26 meters. Leveraging sensor data 108, 110 from the first sensor 104 (e.g., an IMU) and the second sensor 106 (e.g., a receiver configured to generate an RSSI) with ES-EKF fusion, yields a nearly 80 percent improvement of the overall positioning accuracy over RSSI multilateration. The filtering (e.g., ES-EKF fusion of IMU and GPS) alleviates the long-tailing effect even more and increases the accuracy of positioning over ES-EKF fusion of IMU and RSSI. Leveraging sensor data 108, 110 from the first sensor 104 (e.g., an IMU) and the second sensor 106 (e.g., a receiver configured to receive GPS) with ES-EKF fusion, yields a nearly 90 percent improvement of the overall positioning accuracy over RSSI multilateration.

The graph 304 depicts the disparity of positioning accuracy between the use of two different filters (e.g., RSSI multilateration and ES-EKF fusion) between the first sensor 104 (e.g., an IMU) and the second sensor 106 (e.g., a receiver configured to generate an RSSI). The graph 304 shows that the RSSI multilateration results deviate from the true trajectory, while the ES-EKF fusion results closely align with the true trajectory.

The graph 306 demonstrates the time-based variation of different algorithms' positioning error, with ES-EKF of IMU and GPS serving as the baseline. As depicted, similar patterns between ES-EKF of IMU+RSSI and RSSI multilateration is shown with some error peaks occurring at the same time periods but at a lower magnitude in the ES-EKF. This may imply that sensor filtering (e.g., fusion) tends to attenuate the error from RSSI. Moreover, ES-EKF filtering (e.g., fusion) reduces the variance in position uncertainty, achieving a two-magnitude reduction on the variance of positioning error over RSSI multilateration.

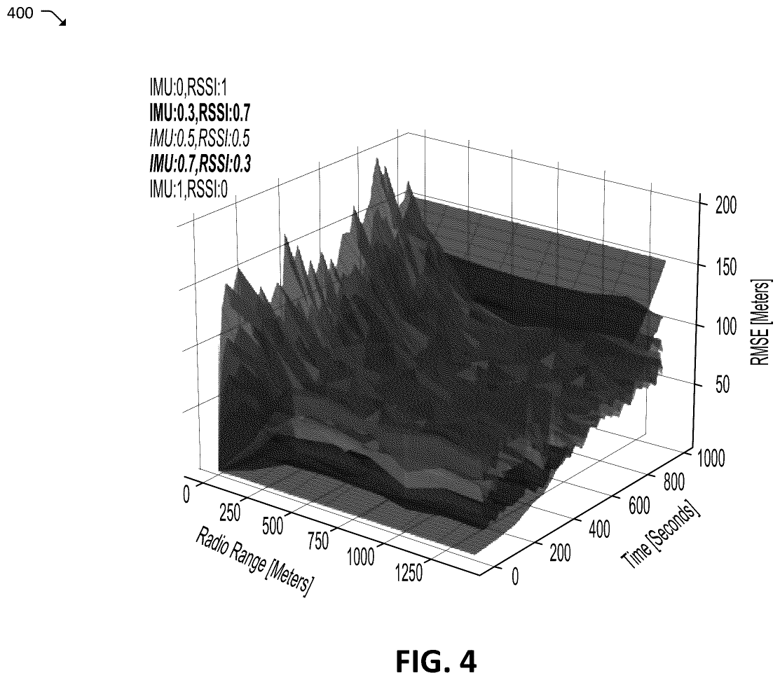

FIG. 4 is an illustration of a graph 400 depicting various position estimates based on weighed fusion of IMU data (e.g., first sensor data 108) and RSSI data (e.g., second sensor data 110). The graph 400 is generated by taking an average of the position estimates with different weightings. Since RSSI and IMU are orthogonal methods, data fusion, using the filter, can enhance the accuracy of RSSI-based location estimates when the radio range is short and reduces the instability of IMU-based location estimates over time. The fusion of the first sensor data 108 and the second sensor data 110 improves the results of determining the inferred location 140.

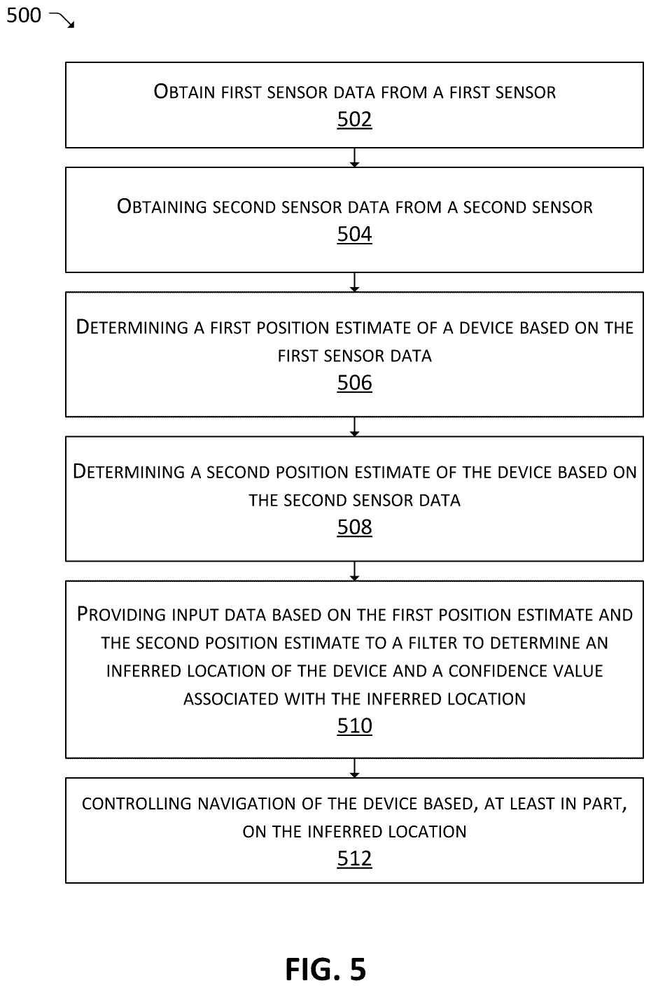

FIG. 5 is a flow chart of a method 500 of determining an inferred location. The method 500 includes, at block 502, obtaining first sensor data 108 from a first sensor 104. For example, the first sensor 104 can include an IMU, in which case the first sensor data 108 includes acceleration, orientation, angular rates, other gravitational forces, or a combination thereof. In other examples, the first sensor 104 can include a communication sensor, a receiver configured to generate a received signal strength indicator (RSSI) based on a received signal, a camera, and so forth.

The method 500 includes, at block 504, obtaining second sensor data 110 from the second sensor 106 of the two or more sensors. For example, the second sensor 106 can include a receiver configured to generate an RSSI, in which case the second sensor data 110 includes measurements of a power level of a received radio signal and angle of arrival to estimate a distance and angle to neighboring devices or ground stations. In other examples, the second sensor 106 can include a second IMU, a communication sensor, a camera, and so forth.

The method 500 includes, at block 506, determining a first position estimate 118 of a device 102 based on the first sensor data 108 and, at block 508, determining a second position estimate 126 of the device 102 based on the second sensor data 110. The way the first position estimate 118 and the second position estimate 126 are determined depends on the sensor type. For example, in implementations in which the first PID 112 is coupled to an IMU (e.g., the first sensor 104 is an IMU), the location derivation 116 receives sensor data such as the angular speed and acceleration on three axes. In this example, the location derivation 116 determines the first position estimate 118 by processing the angular speed and acceleration information to estimate a change of position of the device 102 from a prior known position, as described in FIG. 1. In another example, in implementations in which the second PID 120 is coupled to a receiver configured to generate an RSSI (e.g., the second sensor 106 is the receiver), the location derivation 124 receives signal strength of signals exchanged with or between other devices 128 that are nearby or ground stations. The location derivation 124 determines the second position estimate 126 based on estimates of distances between the device 102 and the other devices 128, ground stations, or a combination thereof.

The method 500 includes, at block 510, providing input data 136 based on the first position estimate 118 and the second position estimate 126 to the filter 138 to determine an inferred location 140 of the device 102 and a confidence value 152 associated with the inferred location 140. For example, the filter 138 can include an error state extended Kalman filter (ES-EKF). In this example, the input data 136 can be processed using an ES-EKF algorithm (as shown above in the description of FIG. 1) to generate an inferred location 140 based on the first sensor data 108 and the second sensor data 110.

The method 500 includes, at block 512, controlling navigation of the device 102 based, at least in part, on the inferred location 140. For example, during a time period that the spoof detector 146 has determined that the GPS signal 164 has been spoofed, the device 102 uses the sensor data 108, 110, 130 or a combination thereof, to determine an inferred location 140 of the device 102 and control its navigation based at least in part on the inferred location 140.

FIG. 6 is a block diagram of a computing environment 600 including a computing device 610 configured to support aspects of computer-implemented methods and computer-executable program instructions (or code) according to the present disclosure. For example, the computing device 610, or portions thereof, is configured to execute instructions to initiate, perform, or control one or more operations described with reference to FIGS. 1-5.

The computing device 610 includes one or more processors 620. The processor(s) 620 are configured to communicate with system memory 630, one or more storage devices 640, one or more input/output interfaces 650, one or more communications interfaces 660, or any combination thereof. The system memory 630 includes volatile memory devices (e.g., random access memory (RAM) devices), nonvolatile memory devices (e.g., read-only memory (ROM) devices, programmable read-only memory, and flash memory), or both. The system memory 630 stores an operating system 632, which may include a basic input/output system for booting the computing device 610 as well as a full operating system to enable the computing device 610 to interact with users, other programs, and other devices. The system memory 630 stores system program data 636, such as any data used or generated by the system 100, one or more modules, one or more machine learning models, or a combination thereof, as described with reference to FIGS. 1-5.

The system memory 630 includes one or more applications 634 (e.g., sets of instructions) executable by the processor(s) 620. As an example, the one or more applications 634 include instructions executable by the processor(s) 620 to initiate, control, or perform one or more operations described with reference to FIGS. 1-6. To illustrate, the one or more applications 634 include instructions executable by the processor(s) 620 to initiate, control, or perform one or more operations described with reference to the prefilter 114, 122, the location derivation 116, 124, the transceiver 132, the intent-based weighting 134, the filter 138, the output tuner 142, the location-based application 150, the spoof detector 146, or a combination thereof.

In a particular implementation, the system memory 630 includes a non-transitory, computer readable medium storing the instructions that, when executed by the processor(s) 620, cause the processor(s) 620 to initiate, perform, or control operations to aid in determining an inferred location and a confidence value. The operations include obtaining first sensor data from a first sensor. The operations include obtaining second sensor data from a second sensor. The operations include determining a first position estimate of a device based on the first sensor data. The operations include determining a second position estimate of the device based on the second sensor data. The operations include providing input data based on the first position estimate and the second position estimate to a filter to determine an inferred location of the device and a confidence value associated with the inferred location. The operations include controlling navigation of the device based, at least in part, on the inferred location.

The one or more storage devices 640 include nonvolatile storage devices, such as magnetic disks, optical disks, or flash memory devices. In a particular example, the storage devices 640 include both removable and non-removable memory devices. The storage devices 640 are configured to store an operating system, images of operating systems, applications (e.g., one or more of the applications 634), and program data (e.g., the program data 636). In a particular aspect, the system memory 630, the storage devices 640, or both, include tangible computer-readable media. In a particular aspect, one or more of the storage devices 640 are external to the computing device 610.

The one or more input/output interfaces 650 enable the computing device 610 to communicate with one or more input/output devices 670 to facilitate user interaction. For example, the one or more input/output interfaces 650 can include a display interface, an input interface, or both. For example, the input/output interface 650 is adapted to receive input from a user, to receive input from another computing device, or a combination thereof. In some implementations, the input/output interface 650 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 670 includes one or more user interface devices and displays, including some combination of buttons, keyboards, pointing devices, displays, speakers, microphones, touch screens, and other devices.

The processor(s) 620 are configured to communicate with devices or controllers 680 via the one or more communications interfaces 660. For example, the one or more communications interfaces 660 can include a network interface. The devices or controllers 680 can include, for example, the prefilter 114, 122, the location derivation 116, 124, the transceiver 132, the intent-based weighting 134, the filter 138, the output tuner 142, the location-based application 150, the spoof detector 146, or any combination thereof.

In some implementations, a non-transitory, computer readable medium stores instructions that, when executed by one or more processors, cause the one or more processors to initiate, perform, or control operations to perform part or all of the functionality described above. For example, the instructions may be executable to implement one or more of the operations or methods of FIGS. 1-6. In some implementations, part, or all of one or more of the operations or methods of FIGS. 1-6 may be implemented by one or more processors (e.g., one or more central processing units (CPUs), one or more graphics processing units (GPUs), one or more digital signal processors (DSPs)) executing instructions, by dedicated hardware circuitry, or any combination thereof.

The illustrations of the examples described herein are intended to provide a general understanding of the structure of the various implementations. The illustrations are not intended to serve as a complete description of all of the elements and features of apparatus and systems that utilize the structures or methods described herein. Many other implementations can be apparent to those of skill in the art upon reviewing the disclosure. Other implementations can be utilized and derived from the disclosure, such that structural and logical substitutions and changes can be made without departing from the scope of the disclosure. For example, method operations can be performed in a different order than shown in the figures or one or more method operations can be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results can be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features can be grouped together or described in a single implementation for the purpose of streamlining the disclosure. Examples described above illustrate but do not limit the disclosure. It should also be understood that numerous modifications and variations are possible in accordance with the principles of the subject disclosure. As the following claims reflect, the claimed subject matter can be directed to less than all of the features of any of the disclosed examples. Accordingly, the scope of the disclosure is defined by the following claims and their equivalents.

Particular aspects of the disclosure are described below in sets of interrelated Examples:

According to Example 1, a device includes two or more sensors; and one or more processors coupled to a memory and configured to obtain first sensor data from a first sensor of the two or more sensors; obtain second sensor data from a second sensor of the two or more sensors; determine a first position estimate of the device based on the first sensor data; determine a second position estimate of the device based on the second sensor data; provide input data based on the first position estimate and the second position estimate to a filter to determine an inferred location of the device and a confidence value associated with the inferred location; and control navigation of the device based, at least in part, on the inferred location.

Example 2 includes the device of Example 1, further comprising configuration settings indicating a first weighting associated with the first sensor data and a second weighting associated with the second sensor data.

Example 3 includes the device of Example 1 or Example 2, wherein the configuration settings are user specified or automatically generated.

Example 4 includes the device of any of Example 2 to Example 3, wherein the configuration settings are based on an operational activity associated with the device or an operating environment associated with the device.

Example 5 includes the device of any of Example 2 to Example 4, wherein the configuration settings modify state parameters of the filter.

Example 6 includes the device of any of Example 2 to Example 5, wherein the configuration settings are based, at least in part, on a planned swarm movement pattern of the device and one or more other devices.

Example 7 includes the device of Examples 6, wherein the planned swarm movement pattern is a formation or collective movement of the device and the one or more other devices, wherein the input data is further based on received movement data from the one or more other devices, and wherein the movement data is indicative of a position estimate within the formation of each of the one or more other devices or movements of each of the one or more other devices associated with the collective movement.

Example 8 includes the device of Example 6 or Example 7, wherein the planned swarm movement pattern is indicative of independent movements associated with each of the one or more other devices, and wherein the input data is further based on movement data indicative of a position estimate for individual ones of the one or more other devices, and wherein a de-emphasized weighting is associated with each position estimate.

Example 9 includes the device of any of Example 1 to Example 8, wherein the input data is further based on feedback based on an output of the filter.

Example 10 includes the device of any of Example 1 to Example 9, wherein the one or more processors are further configured to generate an indication of whether a global positioning satellite signal is reliable.

Example 11 includes the device of any of Example 1 to Example 10 and further includes a receiver configured to receive signals from one or more other devices.

Example 12 includes the device of any of Example 11, wherein the one or more processors are further configured to determine a received signal strength indicator (RSSI) based on the received signals; and determine relative positions of the device and each of the one or more other devices based on the RSSI and known signal transmission parameters.

Example 13 includes the device of Example 11 or Example 12, wherein the one or more processors are further configured to receive a first signal from a second device, wherein the first signal indicates a first RSSI of a signal received from the device; based on the first signal, determine a first estimate of a first distance from the second device to the device; receive a second signal from a third device, wherein the second signal indicates a second RSSI of a signal received from the second device; and based on the second signal determine a second estimate of a second distance from the second device to the third device.

Example 14 includes the device of any of Example 11 to Example 13, wherein the one or more processors are further configured to determine an angle of arrival of the received signals; based on the angle of arrival, determine an estimate of angle of each of the one or more other devices with respect to the device; and based on the estimate of angle, determine an estimate of position of each of the one or more other devices.

Example 15 includes the device of any of Example 1 to Example 14, wherein the two or more sensors includes one or more of: an inertial measurement unit (IMU), an inter-communication device, a RSSI sensor, a camera, or a combination of the above

[symbol]

According to Example 16, a method includes obtaining first sensor data from a first sensor; obtaining second sensor data from a second sensor; determining a first position estimate of a device based on the first sensor data; determining a second position estimate of the device based on the second sensor data; providing input data based on the first position estimate and the second position estimate to a filter to determine an inferred location of the device and a confidence value associated with the inferred location; and controlling navigation of the device based, at least in part, on the inferred location.

Example 17 includes the method of Example 16, wherein the input data is further based on configuration settings indicating a first weighting associated with the first position estimate and a second weighting associated with the second position estimate.

Example 18 includes the method of Example 16 or Example 17, wherein the configuration settings are based on an operational activity associated with the device or an operating environment associated with the device.

Example 19 includes the method of any of Example 16 to Example 18, wherein the input data is further based on feedback based on an output of the filter.

According to Example 20, a non-transitory computer-readable medium stores instructions that, when executed by one or more processors, cause the one or more processors to obtain first sensor data from a first sensor; obtain second sensor data from a second sensor; determine a first position estimate of a device based on the first sensor data; determine a second position estimate of the device based on the second sensor data; provide input data based on the first position estimate and the second position estimate to a Kalman filter to determine an inferred location of the device and a confidence value associated with the inferred location; and control navigation of the device based, at least in part, on the inferred location.

What is claimed is:

1. A device comprising:
two or more sensors; and
one or more processors coupled to a memory and configured to:
obtain first sensor data from a first sensor of the two or more sensors;
obtain second sensor data from a second sensor of the two or more sensors;
determine a first position estimate of the device based on the first sensor data;
determine a second position estimate of the device based on the second sensor data;
provide input data based on the first position estimate and the second position estimate to a filter to determine an inferred location of the device and a confidence value associated with the inferred location; and
control navigation of the device based, at least in part, on the inferred location.

2. The device of claim 1, further comprising configuration settings indicating a first weighting associated with the first sensor data and a second weighting associated with the second sensor data.

3. The device of claim 2, wherein the configuration settings are user specified or automatically generated.

4. The device of claim 2, wherein the configuration settings are based on an operational activity associated with the device or an operating environment associated with the device.

5. The device of claim 2, wherein the configuration settings modify state parameters of the filter.

6. The device of claim 2, wherein the configuration settings are based, at least in part, on a planned swarm movement pattern of the device and one or more other devices.

7. The device of claim 6, wherein the planned swarm movement pattern is a formation or collective movement of the device and the one or more other devices, wherein the input data is further based on received movement data from the one or more other devices, and wherein the movement data is indicative of a position estimate within the formation of each of the one or more other devices or movements of each of the one or more other devices associated with the collective movement.

8. The device of claim 6, wherein the planned swarm movement pattern is indicative of independent movements associated with each of the one or more other devices, and wherein the input data is further based on movement data indicative of a position estimate for individual ones of the one or more other devices, and wherein a de-emphasized weighting is associated with each position estimate.

9. The device of claim 1, wherein the input data is further based on feedback based on an output of the filter.

10. The device of claim 1, wherein the one or more processors are further configured to generate an indication of whether a global positioning satellite signal is reliable.

11. The device of claim 1, further comprising a receiver configured to receive signals from one or more other devices.

12. The device of claim 11, wherein the one or more processors are further configured to:
determine a received signal strength indicator (RSSI) based on the received signals; and
determine relative positions of the device and each of the one or more other devices based on the RSSI and known signal transmission parameters.

13. The device of claim 11, wherein the one or more processors are further configured to:
receive a first signal from a second device, wherein the first signal indicates a first RSSI of a signal received from the device;
based on the first signal, determine a first estimate of a first distance from the second device to the device;
receive a second signal from a third device, wherein the second signal indicates a second RSSI of a signal received from the second device; and
based on the second signal determine a second estimate of a second distance from the second device to the third device.

14. The device of claim 11, wherein the one or more processors are further configured to:
determine an angle of arrival of the received signals;
based on the angle of arrival, determine an estimate of angle of each of the one or more other devices with respect to the device; and
based on the estimate of angle, determine an estimate of position of each of the one or more other devices.

15. The device of claim 1, wherein the two or more sensors includes one or more of:
an inertial measurement unit (IMU),
an inter-communication device,
a RSSI sensor,
a camera, or
a combination thereof.

16. A method comprising:
obtaining first sensor data from a first sensor;
obtaining second sensor data from a second sensor;
determining a first position estimate of a device based on the first sensor data;
determining a second position estimate of the device based on the second sensor data;
providing input data based on the first position estimate and the second position estimate to a filter to determine an inferred location of the device and a confidence value associated with the inferred location; and
controlling navigation of the device based, at least in part, on the inferred location.

17. The method of claim 16, wherein the input data is further based on configuration settings indicating a first weighting associated with the first position estimate and a second weighting associated with the second position estimate.

18. The method of claim 17, wherein the configuration settings are based on an operational activity associated with the device or an operating environment associated with the device.

19. The method of claim 16, wherein the input data is further based on feedback based on an output of the filter.

20. A non-transitory computer-readable medium storing instructions that, when executed by one or more processors, cause the one or more processors to:
obtain first sensor data from a first sensor;
obtain second sensor data from a second sensor;
determine a first position estimate of a device based on the first sensor data;
determine a second position estimate of the device based on the second sensor data;
provide input data based on the first position estimate and the second position estimate to a Kalman filter to determine an inferred location of the device and a confidence value associated with the inferred location; and
control navigation of the device based, at least in part, on the inferred location.
